(19) United States
(12) Patent Application Publication
(10) Pub. No.: US 2007/0143546 A1
(43) Pub. Date: Jun. 21, 2007

(54) Partitioned shared cache

(75) Inventor: Charles Narad, Los Altos, CA (US)

Correspondence Address: CAVEN & AGHEVLI;c/o INTELLEVATE, P.O. BOX 52050, MINNEAPOLIS, MN, 55402, US

(73) Assignee: Intel Corporation

(21) Appl. No.: 11/314,229

(22) Filed: Dec. 21, 2005

(51) Int. Cl. G06F 12/00

(52) U.S. Cl. 711/130

(57) ABSTRACT

Some of the embodiments discussed herein may utilize partitions within a shared cache in various computing environments. In an embodiment, data shared between two memory accessing agents may be stored in a shared partition of the shared cache. Additionally, data accessed by one of the memory accessing agents may be stored in one or more private partitions of the shared cache.

### BACKGROUND

To improve performance, some computing systems utilize multiple processors. These computing systems may also include a cache that can be shared by the multiple processors. The processors may, however, have differing cache usage behavior. For example, some processors may be using the shared cache for high throughput data. As a result, these processors may flush the shared cache too frequently to permit the remaining processors (that may be processing lower throughput data) to effectively cache their data in the shared cache.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1, 3, and 5 illustrate block diagrams of computing systems in accordance with various embodiments of the invention.

FIG. 2 illustrates a flow diagram of an embodiment of a method to utilize a partitioned shared cache.

FIG. 4 illustrates a block diagram of an embodiment of a distributed processing platform.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention.

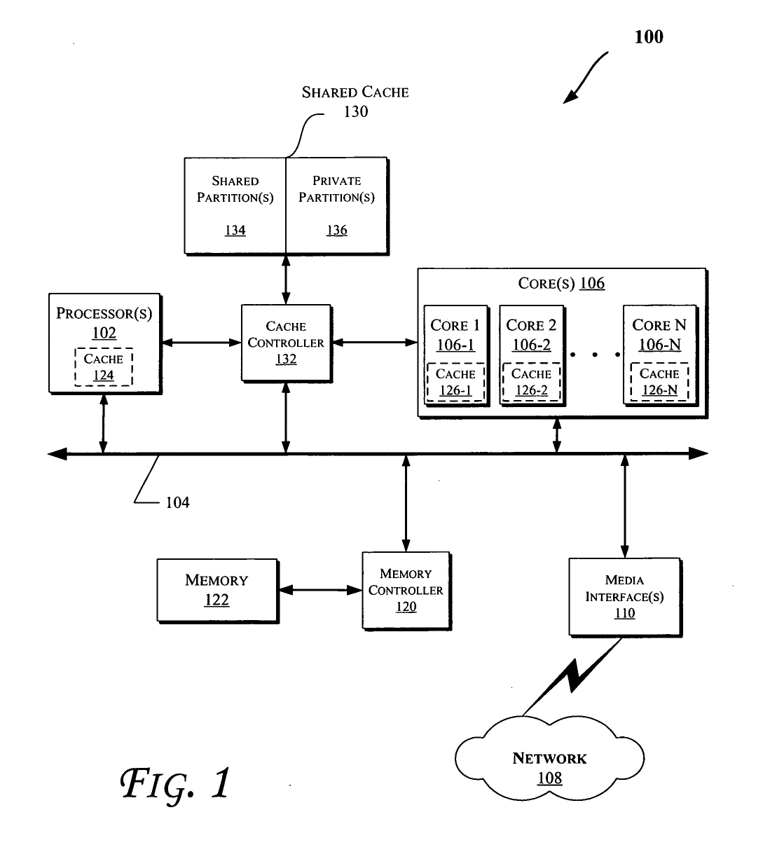

Some of the embodiments discussed herein may utilize partitions within a shared cache in various computing environments, such as those discussed with reference to FIGS. 1 and 3 through 5. More particularly, FIG. 1 illustrates a block diagram of portions of a multiprocessor computing system 100, in accordance with an embodiment of the invention. The system 100 includes one or more processors 102 (referred to herein as “processors 102” or more generally “processor 102”). The processors 102 may communicate through a bus (or interconnection network) 104 with other components of the system 100, such as one or more cores 106-1 through 106-N (referred to herein as “cores 106” or more generally “core 106”).

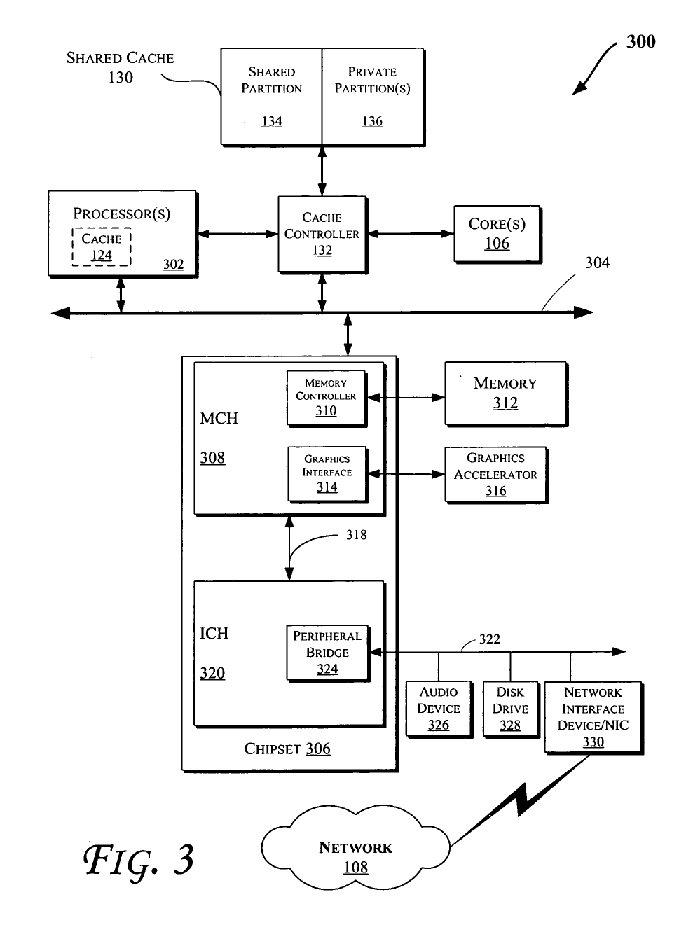

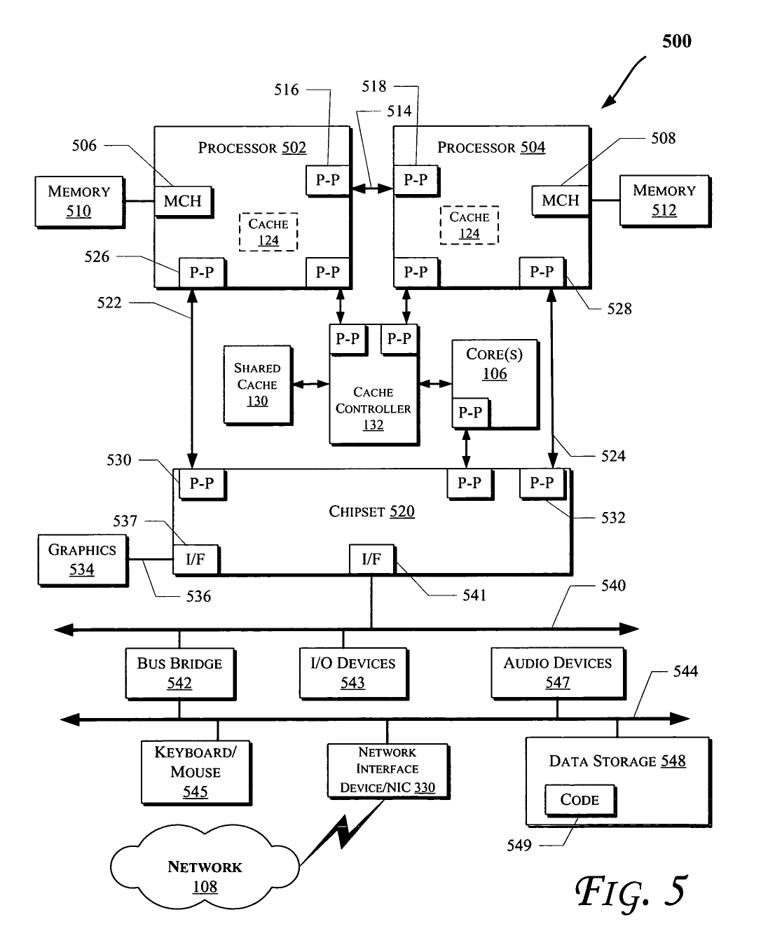

As will be further discussed with reference to FIGS. 3 and 5, any type of a multiprocessor system may include the processor cores 106 and/or the processor 102. Also, the processor cores 106 and/or the processors 102 may be provided on the same integrated circuit die. Furthermore, in an embodiment, at least one of the processors 102 may include one or more processor cores. In one embodiment, the cores in the processor 102 may be homogenous or heterogeneous with the cores 106.

In one embodiment, the system 100 may process data communicated through a computer network 108. For example, each of the processor cores 106 may execute one or more threads to process data communicated via the network 108. In an embodiment, the processor cores 106 may be, for example, one or more microengines (MEs), network processor engines (NPEs), and/or streaming processors (that process data corresponding to a stream of data such as graphics, audio, or other types of real-time data). Additionally, the processor 102 may be a general processor (e.g., to perform various general tasks within the system 100). In an embodiment, the processor cores 106 may provide hardware acceleration related to tasks such as data encryption or the like. The system 100 may also include one or more media interfaces 110 that provide a physical interface for various components of the system 100 to communicate with the network 108. In one embodiment, the system 100 may include one media interface 110 for each of the processor cores 106 and processors 102.

As shown in FIG. 1, the system 100 may also include a memory controller 120 that communicates with the bus 104 and provides access to a memory 122. The memory 122 may be shared by the processor 102, the processor cores 106, and/or other components that communicate through the bus 104. The memory 122 may store data, including sequences of instructions that are executed by the processors 102 and/or the processor cores 106, or other device included in the system 100. For example, the memory 122 may store data corresponding to one or more data packets communicated over the network 108.

In an embodiment, the memory 122 may include one or more volatile storage (or memory) devices such as those discussed with reference to FIG. 3. Moreover, the memory 122 may include nonvolatile memory (in addition to or instead of volatile memory) such as those discussed with reference to FIG. 3. Hence, the system 100 may include volatile and/or nonvolatile memory (or storage). Additionally, multiple storage devices (including volatile and/or nonvolatile memory) may be coupled to the bus 104 (not shown). In an embodiment, the memory controller 120 may comprise a plurality of memory controllers 120 and associated memories 122. Further, in one embodiment, the bus 104 may comprise a multiplicity of busses 104 or a fabric.

Additionally, the processor 102 and cores 106 may communicate with a shared cache 130 through a cache controller 132. As illustrated in FIG. 1, the cache controller 132 may communicate with the processors 102 and cores 106 through the bus 104 and/or directly (e.g., through a separate cache port for each of the processors 102 and cores 106). Hence, the cache controller 132 may provide a first memory accessing agent (e.g., processor 102) and a second memory accessing agent (e.g., cores 106) with access (e.g., read or write) to the shared cache 130. In one embodiment, the shared cache 130 may be a level 2 (L2) cache, a cache with a higher level than 2 (e.g., level 3 or level 4), or a last level cache (LLC). Further, one or more of the processors 102 and cores 106 may include one or more caches such as a level 1 cache (e.g., caches 124 and 126-1 through 126-N (referred to herein as “caches 126” or more generally “cache 126”), respectively) in various embodiments. In one embodiment, a cache (e.g., such as caches 124 and/or 126) may represent a single unified cache. In another embodiment, a cache (e.g., such as caches 124 and/or 126) may include a plurality of caches configured in a multiple level hierarchy. Further, a level of this hierarchy may include a plurality of heterogeneous or homogeneous caches (e.g. a data cache and an instruction cache).

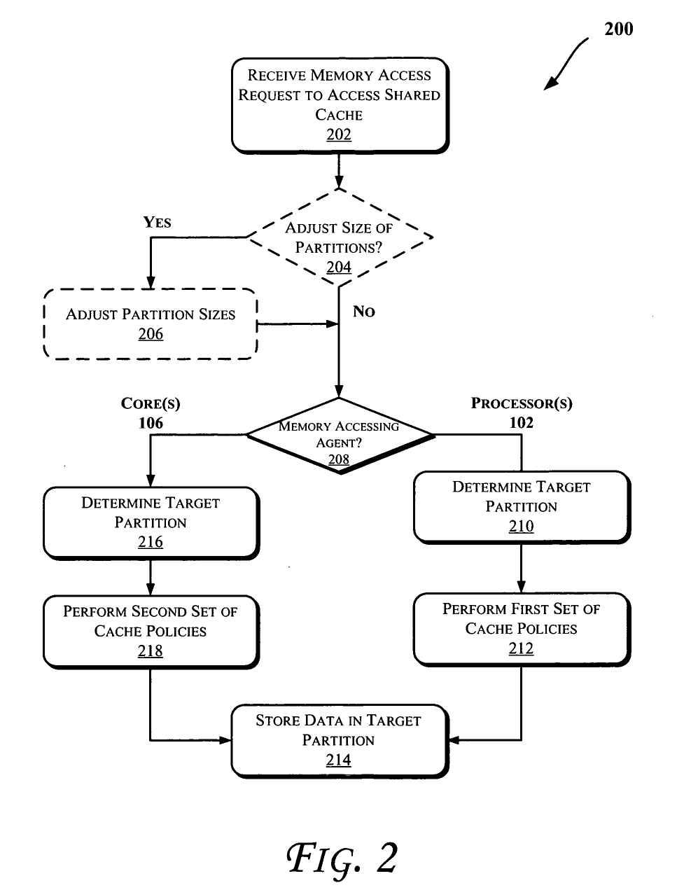

As illustrated in FIG. 1, the shared cache 130 may include one or more shared partitions 134 (e.g., to store data that is shared between various groupings of the cores 106 and/or the processor 102 (or one or more of the cores in processor 102) and one or more private partitions 136. For example, one or more of the private partitions may store data that is only accessed by one or more of the cores 106; whereas, other private partition(s) may stored data that is only accessed by the processor 102 (or one or more cores within the processor 102). Accordingly, the shared partition 134 may allow the cores 106 to participate in coherent cache memory communication with the processor 102. Moreover, each of the partitions 134 and 136 may represent independent domains of coherence in an embodiment. Additionally, the system 100 may include one or more other caches (such as caches 124 and 126, other mid-level caches, or LLCs (not shown)) that participate in a cache coherence protocol with the shared cache 130. Also, each of the caches may participate in a cache coherence protocol with one or more of the partitions 134 and/or 136 in one embodiment, e.g., to provide one or more cache coherence domains within the system 100. Furthermore, even though the partitions 134 and 136 illustrated in FIG. 1 appear to have the same size, these partitions may have different sizes (that is adjustable), as will be further discussed with reference to FIG. 2.

FIG. 2 illustrates a flow diagram of an embodiment of a method 200 to utilize a partitioned shared cache. In various embodiments, one or more of the operations discussed with reference to the method 200 may be performed by one or more components discussed with reference to FIGS. 1, 3, 4, and/or 5. For example, the method 200 may use the partitions 134 and 136 of the shared cache 130 of FIG. 1 for data storage.

Referring to FIGS. 1 and 2, at an operation 202, the cache controller 132 may receive a memory access request to access (e.g., read from or write to) the shared cache 130 from a memory accessing agent, such as one of the processors 102 or cores 106. In one embodiment, the size of the partitions 134 and 136 may be static or fixed, e.g., determined at system initialization. For example, the size of the partitions 134 and 136 may by static to reduce the effects of using a shared cache partition 134 for differing types of data (e.g., where one processor may be using the shared cache for high throughput data that flushes the shared cache too frequently to permit a remaining processor to effectively cache its data in the shared cache).

In an embodiment, at an optional operation 204, the cache controller 132 may determine whether the size of the partitions 134 and 136 need to be adjusted, for example, when the memory access request of operation 202 requests a larger portion of memory than is currently available in one of the partitions 134 or 136. If partition size adjustment is needed, the cache controller 132 may optionally adjust the size of the partitions 134 and 136 (at operation 206). In an embodiment, as the total size of the shared cache 130 may be fixed, an increase in the size of one partition may result in a size decrease for one or more of the remaining partitions. Accordingly, the size of the partitions 134 and/or 136 may be dynamically adjusted (e.g., at operations 204 and/or 206), e.g., due to cache behavior, memory accessing agent request, data stream behavior, time considerations (such as delay), or other factors. Also, the system 100 may include one or more registers (or variables stored in the memory 122) that correspond to how or when the partitions 134 and 136 may be adjusted. Such register(s) or variable(s) may set boundaries, counts, etc.

At an operation 208, the cache controller 132 may determine which memory accessing agent (e.g., processor 102 or cores 106) initiated the memory access request. This may be determined based on indicia provided with the memory access request (such as one or more bits identifying the source of the memory access request) or the cache port that received the memory access request at operation 202.

In some embodiments, since the cores 106 may have differing cache usage behavior than the processor 102 (e.g., the cores 106 may process high throughput or streaming data that benefits less from caching since the data may be written once and possibly read once, with a relatively long delay in between), different cache policies may be performed for memory access requests by the processor 102 versus the cores 106. Generally, a cache policy may indicate how a cache 130 loads, prefetches, stores, shares, and/or writes back data to a memory 122 in response to a request (e.g., from a requester, a system, or another memory accessing agent). For example, if the cores 106 are utilized as input/output (I/O) agents (e.g., to process data communicated over the network 108), such memory accesses may correspond to smaller blocks of data (e.g., one Dword) than a full cache line (e.g., 32 Bytes). To this end, in one embodiment, at least one of the cores 106 may request the cache controller 132 to perform a partial-write merge (e.g., to merge the smaller blocks of data) in at least one of the private partitions 136. In another example, the cores 106 may identify a select cache policy (including an allocation policy) that is applied to a memory transaction that is directed to the shared cache 130, e.g., for data that does not benefit from caching, a no write-allocate write transaction may be performed. This allows for sending of the data to the memory 122, instead of occupying cache lines in the shared cache 130 for data that is written once and not read again by that agent. Similarly in one embodiment where the data to be written is temporally relevant to another agent which can access the shared cache 130, the cores 106 may identify a cache policy of write allocation to be performed in a select shared partition 134.

Accordingly, for a memory access request (e.g., of operation 202) by the processor 102, at an operation 210, the cache controller 132 may determine to which partition (e.g., the shared partition 134 or one of the private partitions 136) the request (e.g., at operation 202) is directed. In an embodiment, the memory accessing agent (e.g., the processor 102 in this case) may utilize indicia that correspond with the memory access request (e.g., at operation 202) to indicate to which partition the memory access request is directed. For example, the memory accessing agent 102 may tag the memory access request with one or more bits that identify a specific partition within the shared cache 130. Alternatively, the cache controller 132 may determine the target partition of the shared cache 130 based on the address of the memory access request, e.g., a particular address or range of addresses may be stored only in a specific one of the partitions (e.g., 134 or 136) of the shared cache 130. At an operation 212, the cache controller 132 may perform a first set of cache policies on the target partition. At an operation 214, the cache controller 132 may store data corresponding to the memory access request from the processor 102 in the target partition. In an embodiment, one or more caches that have a lower level than the target cache of the operation 210 (e.g., caches 124, or other mid-level caches accessible by the processors 102) may snoop one or more memory transactions directed to the target partition (e.g., of operation 210). Therefore, the caches 124 associated with the processors 102 do not need to snoop memory transactions directed to the private partitions 136 of the cores 106. In an embodiment, this may improve system efficiency, for example, where the cores 106 may process high throughput data that may flush the shared cache 130 too frequently for the processors 102 to be able to effectively cache data in the shared cache 130.

Moreover, for memory access requests by one of the cores 106, at an operation 216, the cache controller 132 may determine to which partition the memory access request is directed. As discussed with reference to operation 210, the memory accessing agent may utilize indicia that correspond with the memory access request (e.g., of operation 202) to indicate to which partition (e.g., partitions 134 or 136) the memory access request is directed. For example, the memory accessing agent 106 may tag the memory access request with one or more bits that identify a specific partition within the shared cache 130. Alternatively, the cache controller 132 may determine the target partition of the shared cache 130 based on the address of the memory access request, e.g., a particular address or range of addresses may be stored only in a specific one of the partitions (e.g., 134 or 136) of the shared cache 130. In an embodiment, a processor core within processor 102 may have access restricted to a specific one of the partitions 134 or 136 for specific transactions and, as a result, any memory access request sent by the processor 102 may not include any partition identification information with the memory access request of operation 202.

At an operation 218, the cache controller 132 may perform a second set of cache policies on one or more partitions of the shared cache 130. The cache controller 132 may store data corresponding to the memory access request by the cores 106 in the target partition (e.g., of operation 216), at operation 214. In an embodiment, the first set of cache policies (e.g., of operation 210) and the second set of cache policies (e.g., of operation 218) may be different. In one embodiment, the first set of cache policies (e.g., of operation 210) may be a subset of the second set of cache policies (e.g., of operation 218). In an embodiment, the first set of cache policies (e.g., of operation 210) may be implicit and the second set of cache policies (e.g., of operation 218) may be explicit. An explicit cache policy generally refers to an implementation where the cache controller 132 receives information regarding which cache policy is utilized at the corresponding operation 212 or 218; whereas, with an implicit cache policy, no information regarding a specific cache policy selection may be provided that corresponds to the request of operation 202.

FIG. 3 illustrates a block diagram of a computing system 300 in accordance with an embodiment of the invention. The computing system 300 may include one or more central processing units (CPUs) 302 or processors (generally referred to herein as “processors 302” or “processor 302”) coupled to an interconnection network (or bus) 304. The processors 302 may be any suitable processor such as a general purpose processor, a network processor (that processes data communicated over a computer network 108), or other types of processors, including a reduced instruction set computer (RISC) processor or a complex instruction set computer (CISC)). Moreover, the processors 302 may have a single or multiple core design. The processors 302 with a multiple core design may integrate different types of processor cores on the same integrated circuit (IC) die. Also, the processors 302 with a multiple core design may be implemented as symmetrical or asymmetrical multiprocessors. Furthermore, the system 300 may include one or more of the processor cores 106, shared caches 130, and/or cache controller 132, discussed with reference to FIGS. 1-2. In one embodiment, the processors 302 may be the same or similar to the processors 102, discussed with reference to FIGS. 1-2. For example, the processors 302 may include the cache 124 of FIG. 1. Additionally, the operations discussed with reference to FIGS. 1-2 may be performed by one or more components of the system 300.

A chipset 306 may also be coupled to the interconnection network 304. The chipset 306 may include a memory control hub (MCH) 308. The MCH 308 may include a memory controller 310 that is coupled to a memory 312. The memory 312 may store data (including sequences of instructions that are executed by the processors 302 and/or cores 106, or any other device included in the computing system 300). In an embodiment, the memory controller 310 and memory 312 may be the same or similar to the memory controller 120 and memory 122 of FIG. 1, respectively. In one embodiment of the invention, the memory 312 may include one or more volatile storage (or memory) devices such as random access memory (RAM), dynamic RAM (DRAM), synchronous DRAM (SDRAM), static RAM (SRAM), or the like. Nonvolatile memory may also be utilized such as a hard disk. Additional devices may be coupled to the interconnection network 304, such as multiple CPUs and/or multiple system memories.

The MCH 308 may also include a graphics interface 314 coupled to a graphics accelerator 316. In one embodiment of the invention, the graphics interface 314 may be coupled to the graphics accelerator 316 via an accelerated graphics port (AGP). In an embodiment of the invention, a display (such as a flat panel display) may be coupled to the graphics interface 314 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 318 may couple the MCH 308 to an input/output control hub (ICH) 320. The ICH 320 may provide an interface to I/O devices coupled to the computing system 300. The ICH 320 may be coupled to a bus 322 through a peripheral bridge (or controller) 324, such as a peripheral component interconnect (PCI) bridge, a universal serial bus (USB) controller, or the like. The bridge 324 may provide a data path between the CPU 302 and peripheral devices. Other types of topologies may be utilized. Also, multiple buses may be coupled to the ICH 320, e.g., through multiple bridges or controllers. Further, these multiple busses may be homogeneous or heterogeneous. Moreover, other peripherals coupled to the ICH 320 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or the like.

The bus 322 may be coupled to an audio device 326, one or more disk drive(s) (or disk interface(s)) 328, and one or more network interface device(s) 330 (which is coupled to the computer network 108). In one embodiment, the network interface device 330 may be a network interface card (NIC). In another embodiment a network interface device 330 may be a storage host bus adapter (HBA) (e.g., to connect to Fibre Channel disks). Other devices may be coupled to the bus 322. Also, various components (such as network interface device 330) may be coupled to the MCH 308 in some embodiments of the invention. In addition, the processor 302 and the MCH 308 may be combined to form a single integrated circuit chip. In an embodiment, the graphics accelerator 316, the ICH 320, the peripheral bridge 324, audio device(s) 326, disk(s) or disk interface(s) 328, and/or network interface(s) 330 may be combined in a single integrated circuit chip in a variety of configurations. Further, that variety of configurations may be combined with the processor 302 and the MCH 308 to form a single integrated circuit chip. Furthermore, the graphics accelerator 316 may be included within the MCH 308 in other embodiments of the invention.

Additionally, the computing system 300 may include volatile and/or nonvolatile memory (or storage). For example, nonvolatile memory may include one or more of the following: read-only memory (ROM), programmable ROM (PROM), erasable PROM (EPROM), electrically EPROM (EEPROM), battery-backed non-volatile memory (NVRAM), a disk drive (e.g., 328), a floppy disk, a compact disk ROM (CD-ROM), a digital versatile disk (DVD), flash memory, a magneto-optical disk, or other types of nonvolatile machine-readable media suitable for storing electronic data (including instructions).

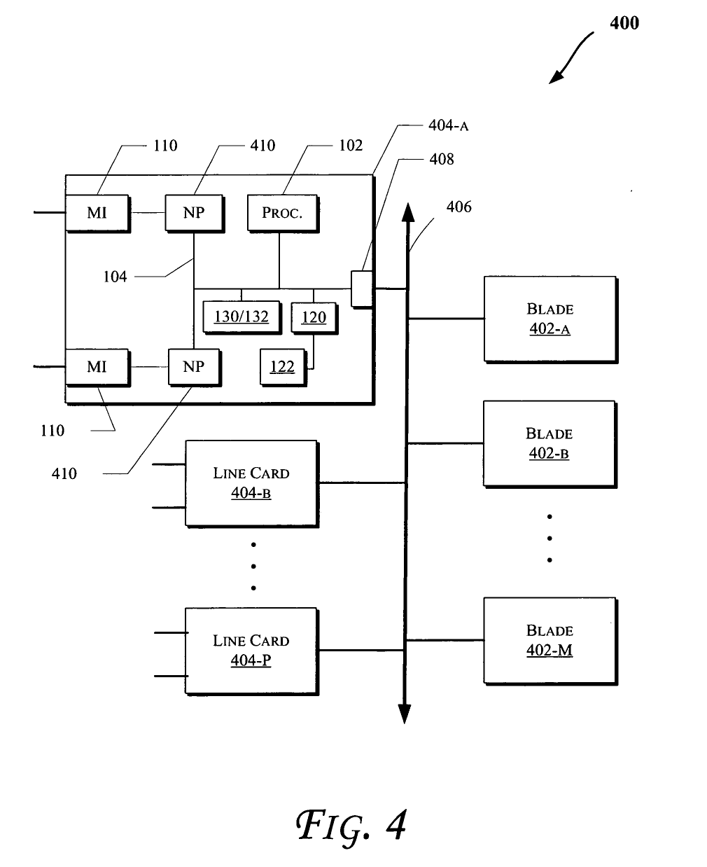

The systems 100 and 300 of FIGS. 1 and 3, respectively, may be used in a variety of applications. In networking applications, for example, it is possible to closely couple packet processing and general purpose processing for optimal, high-throughput communication between packet processing elements of a network processor (e.g., a processor that processes data communicated over a network, for example, in form of data packets) and the control and/or content processing elements. For example, as shown in FIG. 4, an embodiment of a distributed processing platform 400 may include a collection of blades 402-A through 402-M and line cards 404-A through 404-P, interconnected by a backplane 406, e.g., a switch fabric. The switch fabric 406, for example, may conform to common switch interface (CSIX) or other fabric technologies such as advanced switching interconnect (ASI), HyperTransport, Infiniband, peripheral component interconnect (PCI) (and/or PCI Express (PCI-e)), Ethernet, Packet-Over-SONET (synchronous optical network), RapidIO, and/or Universal Test and Operations PHY (physical) Interface for asynchronous transfer mode (ATM) (UTOPIA).

In one embodiment, the line cards 404 may provide line termination and input/output (I/O) processing. The line cards 404 may include processing in the data plane (packet processing) as well as control plane processing to handle the management of policies for execution in the data plane. The blades 402-A through 402-M may include: control blades to handle control plane functions not distributed to line cards; control blades to perform system management functions such as driver enumeration, route table management, global table management, network address translation, and messaging to a control blade; applications and service blades; and/or content processing blades. The switch fabric or fabrics 406 may also reside on one or more blades. In a network infrastructure, content processing blades may be used to handle intensive content-based processing outside the capabilities of the standard line card functionality including voice processing, encryption offload and intrusion-detection where performance demands are high. In an embodiment the functions of control, management, content processing, and/or specialized applications and services processing may be combined in a variety of ways on one or more blades 402.

At least one of the line cards 404, e.g., line card 404-A, is a specialized line card that is implemented based on the architecture of systems 100 and/or 300, to tightly couple the processing intelligence of a processor (such as a general purpose processor or another type of a processor) to the more specialized capabilities of a network processor (e.g., a processor that processes data communicated over a network). The line card 404-A includes one or more media interface(s) 110 to handle communications over a connection (e.g., the network 108 discussed with reference to FIGS. 1-3 or other types of connections such as a storage area network (SAN) connection, for example via a Fibre Channel). One or more media interface(s) 110 may be coupled to a processor, shown here as network processor (NP) 410 (which may be one or more of the processor cores 106 in an embodiment). In this implementation, one NP is used as an ingress processor and the other NP is used as an egress processor, although a single NP may also be used. Alternatively, a series of NPs may be configured as a pipeline to handle different stages of processing of ingress traffic or egress traffic, or both. Other components and interconnections in the platform 400 are as shown in FIG. 1. Here, the bus 104 may be coupled to the switch fabric 406 through an input/output (I/O) block 408. In an embodiment, the bus 104 may be coupled to the I/O block 408 through the memory controller 120. In an embodiment, the I/O block 408 may be a switch device. Further, one or more NP(s) 410 and processors 102 may be coupled to that I/O block 408. Alternatively, or in addition, other applications based on the systems of FIGS. 1 and 3 may be employed by the distributed processing platform 400. For example, for optimized storage processing, such as applications involving an enterprise server, networked storage, offload and storage subsystems applications, the processor 410 may be implemented as an I/O processor. For still other applications, the processor 410 may be a co-processor (used as an accelerator, as an example) or a stand-alone control plane processor. In an embodiment, the processor 410 may include one or more general-purpose and/or specialized processors (or other types of processors), or co-processor(s). In an embodiment, a line card 404 may include one or more of the processor 102. Depending on the configuration of blades 402 and line cards 404, the distributed processing platform 400 may implement a switching device (e.g., switch or router), a server, a gateway, or other type of equipment.

In various embodiments, a shared cache (such as the shared cache 130 of FIG. 1) may be partitioned for use by various components (e.g., portions of the line cards 404 and/or blades 402) of the platform 400, such as discussed with reference to FIGS. 1-3. The shared cache 130 may be coupled to various components of the platform through a cache controller (e.g., the cache controller 132 of FIGS. 1 and 3). Also, the shared cache may be provided in any suitable location within the platform 400, such as within the line cards 404 and/or blades 402, or coupled to the switch fabric 406.

FIG. 5 illustrates a computing system 500 that is arranged in a point-to-point (PtP) configuration, according to an embodiment of the invention. In particular, FIG. 5 shows a system where processors, memory, and input/output devices are interconnected by a number of point-to-point interfaces. The operations discussed with reference to FIGS. 1-4 may be performed by one or more components of the system 500.

As illustrated in FIG. 5, the system 500 may include several processors, of which only two, processors 502 and 504 are shown for clarity. The system 500 may also include one or more of the processor cores 106, shared cache 130, and/or cache controller 132, discussed with reference to FIGS. 1-4, that are in communication with various components of the system 500 through PtP interfaces (such as shown in FIG. 5). Further, the processors 502 and 504 may include the cache(s) 124 discussed with reference to FIG. 1. In one embodiment, the processors 502 and 504 may be similar to processors 102 discussed with reference to FIGS. 1-4. The processors 502 and 504 may each include a local memory controller hub (MCH) 506 and 508 to couple with memories 510 and 512. In the embodiment shown in FIG. 5, the cores 106 may also include a local MCH to couple with a memory (not shown). The memories 510 and/or 512 may store various data such as those discussed with reference to the memories 122 and/or 312 of FIGS. 1 and 3, respectively.

The processors 502 and 504 may be any suitable processor such as those discussed with reference to the processors 302 of FIG. 3. The processors 502 and 504 may exchange data via a point-to-point (PtP) interface 514 using PtP interface circuits 516 and 518, respectively. The processors 502 and 504 may each exchange data with a chipset 520 via individual PtP interfaces 522 and 524 using point to point interface circuits 526, 528, 530, and 532. The chipset 520 may also exchange data with a high-performance graphics circuit 534 via a high-performance graphics interface 536, using a PtP interface circuit 537.

At least one embodiment of the invention may be provided by utilizing the processors 502 and 504. For example, the processor cores 106 may be located within the processors 502 and 504. Other embodiments of the invention, however, may exist in other circuits, logic units, or devices within the system 500 of FIG. 5. Furthermore, other embodiments of the invention may be distributed throughout several circuits, logic units, or devices illustrated in FIG. 5.

The chipset 520 may be coupled to a bus 540 using a PtP interface circuit 541. The bus 540 may have one or more devices coupled to it, such as a bus bridge 542 and I/O devices 543. Via a bus 544, the bus bridge 543 may be coupled to other devices such as a keyboard/mouse 545, network interface device(s) 330 discussed with reference to FIG. 3 (such as modems, network interface cards (NICs), or the like that may be coupled to the computer network 108), audio I/O device, and/or a data storage device(s) or interface(s) 548. The data storage device(s) 548 may store code 549 that may be executed by the processors 502 and/or 504.

In various embodiments of the invention, the operations discussed herein, e.g., with reference to FIGS. 1-5, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include any suitable storage device such as those discussed with respect to FIGS. 1-5.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a first memory accessing agent coupled to a shared cache;
a second memory accessing agent coupled to the shared cache, the second memory accessing agent comprising a plurality of processor cores; and
the shared cache comprising:
a shared partition to store data that is shared between the first memory accessing agent and the second memory accessing agent; and
at least one private partition to store data that is accessed by one or more of the plurality of processor cores.

2. The apparatus of claim 1, further comprising a cache controller to:
perform a first set of cache policies on a first partition of the shared cache for a memory access request by the first memory accessing agent; and
perform a second set of cache policies on one or more of the first partition and a second partition of the shared cache for a memory access request by the second memory accessing agent.

3. The apparatus of claim 2, wherein the first set of cache policies is a subset of the second set of cache policies.

4. The apparatus of claim 1, wherein at least one of the first memory accessing agent or the second memory accessing agent identifies a partition in the shared cache to which a memory access request is directed.

5. The apparatus of claim 1, wherein at least one of the first memory accessing agent or the second memory accessing agent identifies a cache policy that is applied to a memory transaction directed to the shared cache.

6. The apparatus of claim 1, wherein one or more of the plurality of processor cores perform a partial-write merge in one or more private partitions of the shared cache.

7. The apparatus of claim 1, further comprising one or more caches that have a lower level than the shared cache, wherein the one or more caches snoop one or more memory transactions directed to the shared partition.

8. The apparatus of claim 1, wherein the shared cache is one of a level 2 cache, a cache with a higher level than 2, or a last level cache.

9. The apparatus of claim 1, wherein the first agent comprises one or more processors.

10. The apparatus of claim 9, wherein at least one of the one or more processors comprise a level 1 cache.

11. The apparatus of claim 9, wherein at least one of the one or more processors comprises a plurality of caches in a multiple level hierarchy.

12. The apparatus of claim 1, wherein one or more of the plurality of processor cores comprise a level 1 cache.

13. The apparatus of claim 1, wherein at least one of the plurality of processor cores comprises a plurality of caches in a multiple level hierarchy.

14. The apparatus of claim 1, further comprising at least one private partition to store data that is accessed by the first memory accessing agent.

15. The apparatus of claim 1, wherein the first agent comprises at least one processor that comprises a plurality of processor cores.

16. The apparatus of claim 1, wherein the plurality of processor cores are on a same integrated circuit die.

17. The apparatus of claim 1, wherein the first agent comprises one or more processor cores and wherein the first memory accessing agent and the second memory accessing agent are on a same integrated circuit die.

18. A method comprising:
storing data that is shared between a first memory accessing agent and a second memory accessing agent in a shared partition of a shared cache, the second memory accessing agent comprising a plurality of processor cores; and
storing data that is accessed by one or more of the plurality of processor cores in at least one private partition of the shared cache.

19. The method of claim 18, further comprising storing data that is accessed by the first memory accessing agent in one or more private partitions of the shared partition.

20. The method of claim 18, further comprising identifying a cache partition in the shared cache to which a memory access request is directed.

21. The method of claim 18, further comprising:
performing a first set of cache policies on a first partition of the shared cache for a memory access request by the first memory accessing agent; and
performing a second set of cache policies on one or more of the first partition or a second partition of the shared cache for a memory access request by the second memory accessing agent.

22. The method of claim 18, further comprising identifying a cache policy that is applied to a memory transaction directed to the shared cache.

23. The method of claim 18, further comprising performing a partial-write merge in at least one private partition of the shared cache.

24. The method of claim 18, further comprising dynamically or statically adjusting a size of one or more partitions in the shared cache.

25. The method of claim 18, further comprising snooping one or more memory transactions directed to the shared partition of the shared cache.

26. A traffic management device comprising:
a switch fabric; and
an apparatus to process data communicated via the switch fabric comprising:
a cache controller to store the data in one of one or more shared partitions and one or more private partitions of a shared cache in response to a memory access request;
a first memory accessing agent and a second memory accessing agent to send the memory access request, the second memory accessing agent comprising a plurality of processor cores;
at least one of the one or more shared partitions to store data that is shared between the first memory accessing agent and the second memory accessing agent; and
at least one of the one or more private partitions to store data that is accessed by one or more of the plurality of processor cores.

27. The traffic management device of claim 26, wherein the switch fabric conforms to one or more of common switch interface (CSIX), advanced switching interconnect (ASI), HyperTransport, Infiniband, peripheral component interconnect (PCI), PCI Express (PCI-e), Ethernet, Packet-Over-SONET (synchronous optical network), or Universal Test and Operations PHY (physical) Interface for ATM (UTOPIA).

28. The traffic management device of claim 26, wherein the cache controller performs:
a first set of cache policies on a first partition of the shared cache for a memory access request by the first memory accessing agent; and
a second set of cache policies on one or more of the first partition and a second partition of the shared cache for a memory access request by the second memory accessing agent.

29. The traffic management device of claim 26, wherein the first memory accessing agent comprises at least one processor that comprises a plurality of processor cores.

30. The traffic management device of claim 26, further comprising at least one private partition to store data that is accessed by the first memory accessing agent.
